(19) United States
(12) Patent Application Publication
(10) Pub. No.: US 2025/0243126 A1
(43) Pub. Date: Jul. 31, 2025

(54) GRAPHITE-MULLITE JOINT FORMATION

(71) Applicant: Honeywell International Inc., Charlotte, NC (US)

(72) Inventors: Mehrad Mehr, Morristown, NJ (US); Bahram Jadidian, Watchung, NJ (US)

(21) Appl. No.: 18/422,603

(22) Filed: Jan. 25, 2024

(51) Int. Cl. C04B 37/00

(52) U.S. Cl. CPC C04B 37/005; C04B 2237/062; C04B 2237/341; C04B 2237/363; C04B 2237/555

(57) ABSTRACT

An example method includes introducing a slurry comprising particles in a joint region between a first substrate including graphite and a second substrate including mullite. The particles include an ytterbium disilicate compound. The method may further include heating an assembly including the first substrate, the second substrate, and the slurry to form a joint between the first substrate and the second substrate.

### STATEMENT REGARDING FEDERALLY SPONSORED RESEARCH OR DEVELOPMENT

This invention was made with Government support under 80MSFC21CA010 awarded by NASA. The Government has certain rights in the invention.

### TECHNICAL FIELD

The present disclosure relates to forming joints for inorganic substrates, for example, joints between graphite and mullite components.

### BACKGROUND

High-temperature systems may include inorganic components having different compositions. For example, high-temperature components may include carbon, a ceramic, a glass, a metal, or an alloy. Two or more components may be assembled, for example, by joints between the components.

### SUMMARY

In general, the disclosure describes techniques for forming joints for inorganic substrates, for example, joints between graphite and mullite components.

In some examples, an example method includes introducing a slurry including particles in a joint region between a first substrate including graphite and a second substrate including mullite. The particles include an ytterbium disilicate compound. The method may further include heating an assembly including the first substrate, the second substrate, and the slurry to form a joint between the first substrate and the second substrate.

In some examples, an example assembly includes a first substrate including graphite, a second substrate including mullite, and a joint between the first substrate and the second substrate. The joint includes an ytterbium disilicate compound.

The details of one or more examples are set forth in the accompanying drawings and the description below. Other features, objects, and advantages will be apparent from the description and drawings, and from the claims.

### BRIEF DESCRIPTION OF THE FIGURES

The details of one or more examples are set forth in the accompanying drawings and the description below. Other features, objects, and advantages will be apparent from the description and drawings, and from the claims.

FIG. 1 is a partial cross-sectional view of an example assembly including a first substrate including graphite, a second substrate including mullite, and a joint including an ytterbium disilicate compound.

FIG. 2 is a partial cross-sectional view of an example assembly similar to the assembly of FIG. 1, further including a coating including silicon carbide on the first substrate.

FIG. 3A is a partial cross-sectional view of a precursor assembly including the first substrate and the second substrate of FIG. 1 in a first configuration, and with a slurry applied to at least one of the first substrate or the second substrate.

FIG. 3B is a partial cross-sectional view of the precursor assembly of FIG. 3A in a second configuration, with the slurry between the first substrate and the second substrate.

FIG. 4 is a partial side view of an example assembly including a joint between a first substrate including graphite and a second substrate including mullite.

FIG. 5 is a partial cross-sectional view of an example high-temperature system including the assembly of FIG. 4.

FIG. 6 is a flowchart representing a technique for techniques for forming joints for inorganic substrates, for example, joints between graphite and mullite components.

### DETAILED DESCRIPTION

In general, the disclosure describes techniques for forming joints for inorganic substrates, for example, joints between graphite and mullite components.

High-temperature systems, for example, furnaces or reactors may use tubing to deliver fluids in or out of a reaction zone or a hot zone. The tubing may be joined to a retort material of the high-temperature system. Passage of a tube through a thermal barrier (insulation) of a high-temperature system may cause substantial thermal loss by conduction of heat through a tube wall, which may reduce efficiency of the high-temperature system. Tubing including relatively low thermal conductivity material, for example, a ceramic, may resist heat loss. The material used to fabricate a body of a high-temperature system (e.g., a retort) may differ from the material used in tubing. Techniques and assemblies according to the disclosure may be used to form a hermetic seal or joint between components including different materials, for example, a first substrate including graphite, and a second substrate including mullite. The joint may exhibit a relatively low coefficient of thermal expansion mismatch, and may form a glass, that secures the first substrate and the second substrate. The joint may include an ytterbium disilicate compound, which may promote compatibility with one or both of the first substrate or the second substrate, and which may form a hermetic seal, while still exhibiting acceptable thermal characteristics (e.g., relatively low thermal conductivity and low coefficient of thermal expansion mismatch).

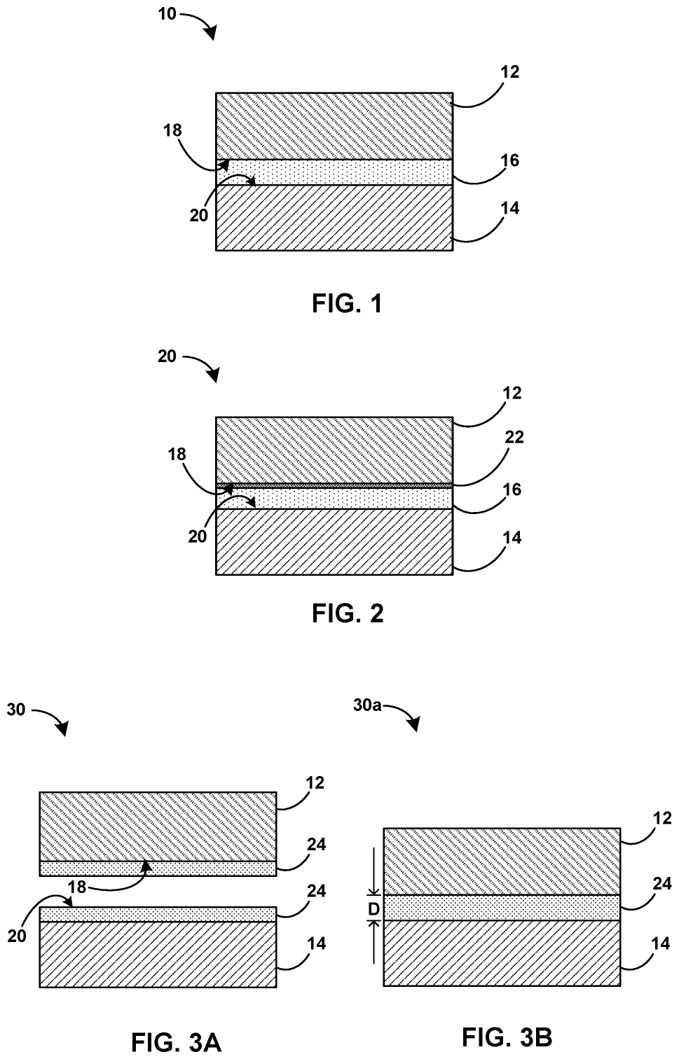

FIG. 1 is a partial cross-sectional view of an example assembly 10 including a first substrate 12 including graphite, a second substrate 14 including mullite, and a joint 16 including an ytterbium disilicate compound. First substrate 12 and second substrate 14 may include respective components of a high-temperature system, for example, of a reactor or a furnace. First substrate 12 and second substrate 14 may have any predetermined shape, size, or orientation.

In some examples, joint 16 includes a glass including ytterbium disilicate. In some examples, the ytterbium disilicate compound includes ytterbium aluminum disilicate. Joint 16 occupies a region between opposing first face 18 defined by first substrate 12 and second face 20 defined by second substrate 14. The presence of the ytterbium disilicate compound in joint 16 promotes the retention of joint 16 between first substrate 12 and second substrate 14. Joint 16 including the ytterbium disilicate compound may be one or both of hermetic or shock resistant. Thus, joint 16 may provide a hermetic seal between first substrate 12 and second substrate 14, and may firmly join first substrate 12 and second substrate 14 to resist separation of substrate 12 and substrate 14.

Joint 16 may further include mullite. For example, joint 16 may include ytterbium disilicate and mullite. In some examples, joint 16 consists of, or consists essentially of, ytterbium disilicate and mullite. Including mullite in joint 16 promotes formation of a liquid composition at elevated temperatures to form ytterbium aluminum silicate glass, and may promote the adherence of and retention of joint 16 to second substrate 14 including mullite.

Joint 16 may have any suitable thickness in a direction between first substrate 12 and second substrate 14. In some examples, joint 16 has a thickness of at least 1 mil (millionths of an inch, 0.0254 mm). In some examples, joint 16 has a thickness of at least 2 mils (0.0508 mm), at least 3 mils (0.0762 mm), at least 4 mils (0.1016 mm), or at least 5 mils (0.1270 mm). In some examples, opposing first face 18 of first substrate 12 and second face 20 of second substrate 20 are substantially level or smooth, such that joint 16 defines a substantially uniform thickness along a plane between first face and second face 20. In other examples, one or both of first face 18 or second face 20 may exhibit roughness, asperities, projections, or other irregularities. Nonetheless, joint 16 may have a substantially uniform average thickness along the plane between first face 18 and second face 20, for example, by smoothening one or both of first face 18 or second face 20.

FIG. 2 is a partial cross-sectional view of an example assembly 20 similar to assembly 10 of FIG. 1, further including a coating 22 including silicon carbide on first substrate 12. Coating 22 including silicon carbide may promote one or more of wettability of first substrate 12, compatibility of joint 16, or retention of joint 16 including the ytterbium disilicate compound on first face 18 of first substrate 12. Coating 22 may be deposited as a separate layer on first face 18, or be formed by treatment of first face 18 to generate coating 22 from a portion of first substrate 12 adjacent first face 18. For example, coating 22 may be formed by an in situ silicon carbide conversion process. In some examples, silicon may be deposited on first face 18, and an interaction or reaction between silicon and the graphite of first substrate 12 may form silicon carbide of coating 22. The silicon carbide may be formed through any suitable method, including conversion reactions, chemical vapor deposition, or from preceramic polymers.

Coating 22 may have any suitable thickness. For example, coating 22 may have a thickness of at least 1%, at least 5%, at least 10%, or at least 20% of an average thickness of joint 16. In some examples, coating 22 has a thickness of at least 0.01 mil (0.000254 mm).

Assembly 10 described with reference to FIG. 1 or assembly 20 described with reference to FIG. 2 may be formed by depositing a slurry on one or both of first substrate 12 or second substrate 14, as described with reference to FIGS. 3A and 3B.

FIG. 3A is a partial cross-sectional view of a precursor assembly 30 including first substrate 12 and second substrate 14 of FIG. 1 in a first configuration, and with a slurry 24 applied to at least one of first substrate 12 or second substrate 14. Slurry 24 is configured to form joint 16. Slurry 24 includes particles including the ytterbium disilicate compound. The particles may have any suitable size, for example, in a range from 50 nm to 5 microns. The particles may exhibit any suitable particle size distribution, including unimodal, bimodal, or trimodal distribution. Slurry 24 further includes a carrier, for example, an aqueous carrier or an organic carrier. Thus, the particles may be suspended in the carrier.

In some examples, slurry 24 is a relatively free-flowing composition. For example, slurry 24 may be configured to be applied to one or both of first face 18 or second face 20 by spraying, slot coating, dipping, or any suitable coating technique. In other examples, slurry 24 is in form of a gel or a paste, and does not flow freely. In some such examples, slurry 24 is configured to be applied to one or both of first face 18 or second face 20 by one or more of extrusion, brushing, spreading, or any suitable mechanical process. The volumetric proportion of carrier in slurry 24 influences the flowability and bulk density of slurry 24. In some examples, the carrier is present in a concentration of less than 80%, less than 70%, or less than 60% of the volume of slurry 24. For example, the carrier may be present in a concentration of less than 50% of slurry 24. In examples in which joint 16 includes mullite, slurry 24 includes mullite particles.

In the first configuration shown in FIG. 3A, first face 18 of first substrate 12 and second face 20 of second substrate 14 are spaced apart from each other. Slurry 24 may be applied to one of first face 18 or second face 20, or both first face 18 and second face 20, as shown in FIG. 3A. The same slurry 24 may be applied to one or both of first face 18 or second face 20, or slurries with different characteristics (e.g., concentration, density, or flowability) may be applied to first face 18 or second face 20. Each of first face 18 and second face 20 may be applied with a substantially same or similar thickness or areal concentration of slurry 24, or with different thicknesses or areal concentrations of slurry 24. After applying slurry 24, one or both of first substrate 12 or second substrate 14 are moved toward each other so that slurry 24 occupies a joint region between first face 18 and second face 20, as shown in FIG. 3B.

FIG. 3B is a partial cross-sectional view of the precursor assembly of FIG. 3A in a second configuration 30b, with slurry 24 between first substrate 12 and second substrate 14. In second configuration 30b, first face 18 and second face 20 are separated by a spacing D, with slurry 24 occupying a joint region in spacing D between first substrate 12 and second substrate 14. In some examples, slurry 24 may exhibit dimensional changes during further treatment to form joint 16, for example, thermal treatment. Thus, the spacing D is based on the thickness of joint 16 to be ultimately formed from slurry 24, and may be selected to account for dimensional changes between slurry 24 into joint 16.

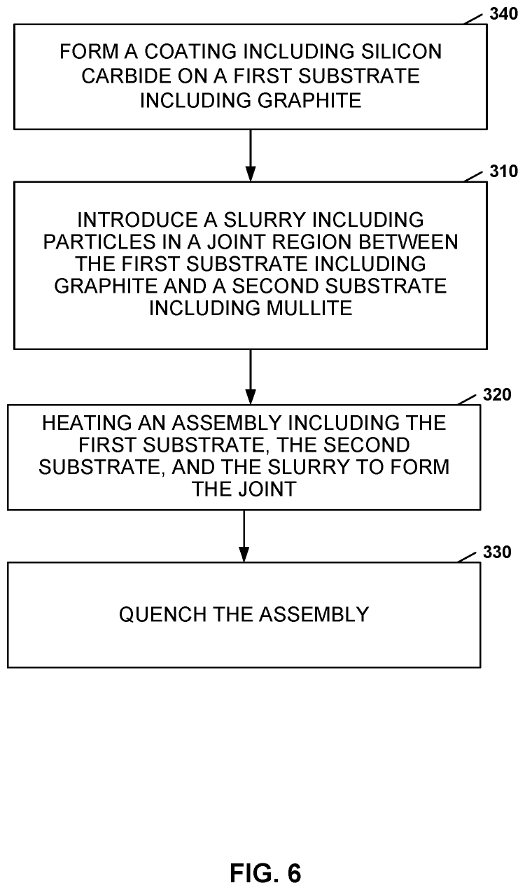

The precursor assembly in second configuration 30b is further treated to form joint 16, from slurry 24, between first substrate 12 and second substrate 14, to form assembly 10 of FIG. 1, as described with reference to the technique of FIG. 6.

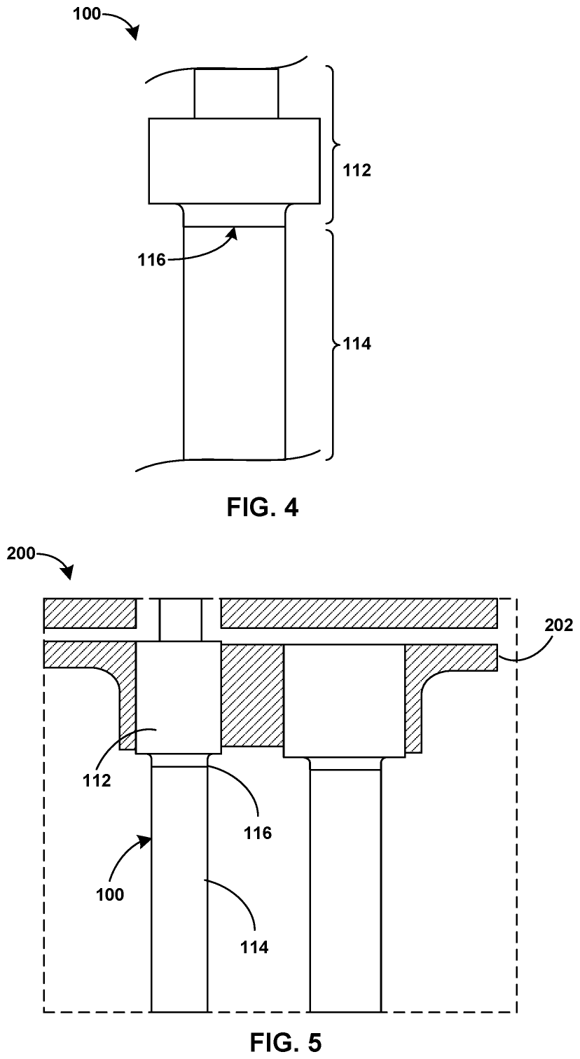

FIG. 4 is a partial side view of an example high-temperature assembly 100 including a joint 116 between a first substrate 112 including graphite and a second substrate 114 including mullite. Joint 116 may be substantially similar to joint 16 described with reference to FIG. 1. First substrate 112 and second substrate 114 may together form tubing or fluid conduits for passage of fluids to and from high-temperature assembly 100. Joint 116 may secure first substrate 112 and second substrate 114 together at relatively high operating temperatures, while retaining fluids within assembly 100, and while reducing thermal loss from assembly 100 into the external environment.

FIG. 5 is a partial cross-sectional view of an example high-temperature system 200 including assembly 100 of FIG. 4. High-temperature system 200 includes a reactor body 202, and assembly 100 extends through reactor body 202. Assembly 100 forms tubing for delivering fluids to and withdrawing fluids from reactor body 202. Reactor body 202 defines a reactor chamber operated at a relatively high operating temperature (e.g., greater than 500° C., greater than 1000° C., or greater than 1500° C.). The combination of graphite in first substrate 112 and mullite in second substrate 114 provides a thermal break and a transition from a ceramic region or material (for example, mullite) to a high-temperature material (for example, graphite) of reactor body 202.

FIG. 6 is a flowchart representing a technique for forming joints for inorganic substrates, for example, joints between graphite and mullite components. While the technique of FIG. 6 is described with reference to assemblies 10, 20, 30, and 30a described with reference to FIGS. 1 to 3B, the technique of FIG. 6 may be used to form any assembly according to the present disclosure. Further, assemblies according to the present disclosure may be formed using any suitable technique.

The technique of FIG. 6 includes introducing slurry 24 including particles in a joint region between first substrate 12 including graphite and second substrate 14 including mullite (310). The particles include an ytterbium disilicate compound. The ytterbium disilicate compound may include ytterbium aluminum disilicate. The ytterbium disilicate may react with mullite to form a liquid at elevated temperatures, which solidifies to a glass. The glass may include ytterbium aluminum silicate. Slurry 24 may further include mullite particles. Slurry 24 may include an aqueous carrier or an organic carrier. The aqueous carrier or organic carrier may be present in a concentration of less than 50% volume of the slurry.

The introducing (310) may include applying slurry 24 to one or both of first substrate 12 or second substrate 14, and first substrate 12 or second substrate 14 may be brought together so that slurry 24 occupies the joint region, for example, between first face 18 and second face 20. In some examples, slurry 24 may be injected or extruded between the joint region from a tube or a container. The introducing may include coating, extruding, brushing, spraying, or spreading slurry 24 on one or both of first face 18 or second face 20, or otherwise within the joint region.

The technique may further include heating assembly 30a including first substrate 12, second substrate 14, and slurry 24 to form joint 16 between first substrate 12 and second substrate 14 (320). The heating (320) may include heating assembly 30a in a furnace, or passing assembly 30a through a thermal tunnel. For example, the heating assembly 30a (320) may cause slurry 24 to form a molten phase that may occupy the joint region, and the molten phase may solidify to form joint 16. In some examples, the heating (320) may initially vaporize or drive off a carrier (e.g., water or an organic carrier) from slurry 24 to leave solid particles, followed by melting of the solid particles to form the molten phase.

The heating (320) may include heating assembly 30a to any suitable temperature to form the molten phase from slurry 24. In some examples, the heating (320) heats assembly 30a to at least 1000° C., at least 1200° C., or at least 1400° C. For example, assembly 30a may be heated to at least 1500° C.

Assembly 30a may be retained at an elevated temperature for a period of time sufficient to at least partially melt slurry 24. In some examples, the heating (320) includes heating assembly 30a to a temperature greater than 1000° C. for a predetermined time period. In some examples, the time period is at least 1 minute. In some examples, the time period is no more than 5 minutes.

After the heating (320), assembly 30a may be allowed to cool, so that the molten phase formed from slurry 24 solidifies to form joint 16. For example, assembly 30a may be withdrawn from the furnace or thermal tunnel to allow assembly 30a to cool. The cooling may include passive cooling by heat dissipation from assembly 30a to an ambient environment, or include active cooling, for example, by a cooling fan, a blower, or a cooling liquid. In some examples, the technique includes quenching heated assembly 30 to form joint 16 by solidification of the molten phase formed by heating assembly 30a (330). The quenching (330) may include spraying a cooling medium onto assembly 30a, or immersing or passing assembly 30a in the cooling medium. The cooling medium may include water.

After the cooling or quenching, joint 16 may include a homogenous matrix or bulk including ytterbium disilicate. For example, joint 16 may include a glass including ytterbium disilicate. Joint 16 may form a hermetic seal between first substrate 12 and second substrate 14.

In some examples, first substrate 12 may be treated before slurry 24 is introduced (310). For example, the technique may further include, before introducing slurry 24 (310), forming coating 22 including silicon carbide on first substrate 12 (340). The forming of coating 22 (340) may include in situ formation of coating 22 on first substrate 12 from a precursor composition. For example, the precursor composition may include silica, or another silicon source, and may be applied to first face 18 of first substrate 12. First substrate 12 may be heated to form silicon carbide by reaction between silica and graphite at first face 18 to form coating 22. In other examples, the forming (340) may include vapor deposition of silicon or silicon carbide on first face 18.

Thus, the example technique of FIG. 6 may be used to form joint 16 including ytterbium disilicate between first substrate 12 and second substrate 14. The following clauses illustrate example subject matter described herein.
Clause 1: A method including: introducing a slurry including particles in a joint region between a first substrate including graphite and a second substrate including mullite, the particles including an ytterbium disilicate compound; and heating an assembly including the first substrate, the second substrate, and the slurry to form a joint between the first substrate and the second substrate.
Clause 2: The method of clause 1, further including quenching the heated assembly to form the joint by solidification of a molten phase formed by heating the assembly.
Clause 3: The method of clauses 1 or 2, where the ytterbium disilicate compound includes ytterbium aluminum disilicate.
Clause 4: The method of any of clauses 1 to 3, where the slurry further includes mullite particles.
Clause 5: The method of any of clauses 1 to 4, where the slurry includes an organic carrier.
Clause 6: The method of clause 5, where the organic carrier is present in a concentration of less than 50% volume of the slurry.
Clause 7: The method of any of clauses 1 to 6, where the particles have a size in a range from 50 nm to 5 microns.
Clause 8: The method of any of clauses 1 to 7, where introducing the slurry includes applying the slurry to one or both of a first face defined by the first substrate or a second face defined by the second substrate.
Clause 9: The method of any of clauses 1 to 8, where the joint has a thickness of at least 1 mil (thousands of an inch).
Clause 10: The method of clause 9, where the joint has a thickness of at least 2 mils.
Clause 11: The method of clause 10, where the joint has a thickness of at least 5 mils.
Clause 12: The method of any of clauses 1 to 11, further including, before introducing the slurry, forming a coating including silicon carbide on the first substrate.
Clause 13: The method of clause 12, where the forming includes in situ formation of the coating on the first substrate from a precursor composition.
Clause 14: The method of any of clauses 1 to 13, where the heating includes heating the assembly to a temperature greater than 1000° C. for a predetermined time period.
Clause 15: The method of clause 14, where the time period is at least 1 minute.
Clause 16: The method of clause 15, where the time period is no more than 5 minutes.
Clause 17: The method of any of clauses 1 to 16, where the joint is hermetic.
Clause 18: An assembly including: a first substrate including graphite; a second substrate including mullite; and a joint between the first substrate and the second substrate, the joint including an ytterbium disilicate compound.
Clause 19: The assembly of clause 18, where the joint further includes mullite.
Clause 20: The assembly of clauses 18 or 19, where the joint has a thickness of at least 1 mil.
Clause 21: The assembly of any of clauses 18 to 20, where the first substrate includes a coating including silicon carbide.
Clause 22: The assembly of any of clauses 18 to 21, where the joint is hermetic.

Various examples have been described. These and other examples are within the scope of the following claims.

What is claimed is:

1. A method comprising:
introducing a slurry comprising particles in a joint region between a first substrate comprising graphite and a second substrate comprising mullite, the particles comprising an ytterbium disilicate compound; and
heating an assembly comprising the first substrate, the second substrate, and the slurry to form a joint between the first substrate and the second substrate.

2. The method of claim 1, further comprising quenching the heated assembly to form the joint by solidification of a molten phase formed by heating the assembly.

3. The method of claim 1, wherein the ytterbium disilicate compound comprises ytterbium aluminum disilicate.

4. The method of claim 1, wherein the slurry further comprises mullite particles.

5. The method of claim 1, wherein the slurry comprises an organic carrier.

6. The method of claim 5, wherein the organic carrier is present in a concentration of less than 50% volume of the slurry.

7. The method of claim 1, wherein the particles have a size in a range from 50 nm to 5 microns.

8. The method of claim 1, wherein introducing the slurry comprises applying the slurry to one or both of a first face defined by the first substrate or a second face defined by the second substrate.

9. The method of claim 1, wherein the joint has a thickness of at least 1 mil (thousandths of an inch).

10. The method of claim 9, wherein the joint has a thickness of at least 2 mils.

11. The method of claim 10, wherein the joint has a thickness of at least 5 mils.

12. The method of claim 1, further comprising, before introducing the slurry, forming a coating comprising silicon carbide on the first substrate.

13. The method of claim 12, wherein the forming comprises in situ formation of the coating on the first substrate from a precursor composition.

14. The method of claim 1, wherein the heating comprises heating the assembly to a temperature greater than 1000° C. for a predetermined time period.

15. The method of claim 14, wherein the time period is at least 1 minute.

16. The method of claim 15, wherein the time period is no more than 5 minutes.

17. The method of claim 1, wherein the joint is hermetic.

18. An assembly comprising:
a first substrate comprising graphite;
a second substrate comprising mullite; and
a joint between the first substrate and the second substrate, the joint comprising an ytterbium disilicate compound.

19. The assembly of claim 18, wherein the joint further comprises mullite.

20. The assembly of claim 18, wherein the joint has a thickness of at least 1 mil.

21. The assembly of claim 18, wherein the first substrate comprises a coating comprising silicon carbide.

22. The assembly of claim 18, wherein the joint is hermetic.
